(19) United States
(12) Patent Application Publication
(10) Pub. No.: US 2007/0051269 A1
(43) Pub. Date: Mar. 8, 2007

(54) Track for a railborne vehicle, comprising a long-stator lenear drive comprising at least one long stator, and a kit and a stator packet for the production thereof

(76) Inventors: Dieter Reichel, Badstrasse (DE); Theo Frisch, Velburg (DE); Ralf Waidhauser, Neumarkt (DE)

Correspondence Address: DORITY & MANNING, P.A., POST OFFICE BOX 1449, GREENVILLE, SC, 29602-1449, US

(21) Appl. No.: 10/552,524

(22) PCT Filed: Mar. 30, 2004
(86) PCT No.: PCT/EP04/03330

§ 371 Date: Jul. 20, 2006

(30) Foreign Application Priority Data
Apr. 11, 2003 (DE) 103-17-014.6

(51) Int. Cl. B60L 13/00

(52) U.S. Cl. 104/286

(57) ABSTRACT

The invention relates to a track for a railborne vehicle, comprising a long-stator linear drive comprising at least one long stator and a plurality of track elements arranged along a line. Said track also comprises a carrier (1) and at least one functional part (2) which is arranged on the carrier and comprises at least one stator carrier (3) which is arranged along the line and is used to receive at least one stator section (4). Said stator section (4) consists of at least one stator packet (5) having a front joining end (6) and a rear joining end (7). The longitudinal extension of the front joining end (6) has a cubical contour (8) projecting out of a cross-sectional plane of the stator packets (5), and the longitudinal extension of the rear joining end (7) has a complementary cubical contour corresponding to the contour (8) of the front joining end. The front joining end (6) and the rear joining end (7) of adjacent stator packets (5) lap in the longitudinal direction.

The invention relates to a track for a railborne vehicle with a long-stator linear drive comprising at least one long stator, with a plurality of track elements arranged along a line, comprising a carrier, at least one functional part arranged on the carrier, which functional part comprises at least one stator carrier arranged along the line for receiving a stator section, which stator section is composed of stator packets with a front and a back joining end, as well as with a kit and a stator packet for its production.

Tracks for railborne vehicles consist off a plurality of track elements arranged successively along the line on which elements other equipment parts are arranged that are required for the operation of vehicles, especially the carrying, guiding, driving and braking. For example, track elements for magnetic suspended railways comprise a carrier on which surfaces for lateral guidance and setting the vehicle down as well as the primary components of the linear drive are mounted.

In a synchronous long-stator linear motor affected by iron the primary component comprises a plurality of stator packets arranged along the line that are provided with continuously alternating teeth and grooves into which a one-phase or multiphase alternating-current traveling-field winding is inserted. The secondary component is housed in the vehicle and comprises magnets that are customarily designed as electromagnets and one the one hand generate the exciter field of the motor and on the other hand act as carrier magnets for the vehicle. The stator packets function as armature for the generation of the carrier force and are stacked in order to suppress eddy currents from stator sheets that are insulated [isolated] from each other.

Such tracks are known, e.g., from DE 197 35, 471 C1. The stator packets consist of individual sheets and have a parallelepipedal base form. The stator packets are fastened to a belt-like stator carrier, for which purpose girder-[traverse-, bar-]like connection elements extending positively into grooves comprising undercuts [back tapers] and screw bolts and nuts are provided on both sides.

In such arrangements the long stator is formed by a chain of successive stator packets and a gap occurs between adjacent stator packets. In a track running along a straight line the material gap width results from an expansion gap component and a mounting [assembly] gap component. The width of the expansion gap is typically a few millimeters and the typical width of a mounting gap is a few tenths of a millimeter. In addition, the stator packets composed of individual sheets are usually surrounded over [sic-by?] corrosion protection coating, e.g., one to two millimeters thick. The active magnetic gap width therefore results from the addition of the doubled thickness of the corrosion protection coating and of the material gap.

In the customary linear drives with several long stators there is the additional problem in curved track sections that the stator lines are shorter in the inner curve than in the outer curve. Thus, there are additional gap components when using stator packets with a uniform length, preferred for reasons of construction and cost. The problem of the curve gap occurs in a more amplified manner in the production of tracks with several lanes. The material gap width results in this instance from the sum of the expansion gap, of the mounting gap and of the curve gap, and the active magnetic gap width from the material gap width and the doubled thickness of the corrosion protection coating.

Such magnetic gaps and generally produce an elevation of the magnetic resistance in a magnetic circuit. Thus, starting with a constant current generating the magnetic field, a lesser magnetic induction results and therewith a lesser electromagnetic action of force. During the travel operation of a magnetic suspended railway the magnetic gaps between two stator packets cause too rapid periodic changes of the carrier and drive forces. Consequently, parts of the track or of the vehicle can be excited to undesired oscillations. Such oscillations can negatively influence, e.g., the service life of system elements as well as the travel comfort and the generation of sound.

DE 199 34 912 A1 teaches a track in which the magnetic gaps are minimized in curved track sections by means of stator packets with differing lengths. However, this track has the disadvantage of the high cost of the manufacture of the stator packets on the one hand and on the other hand during the planning and construction of a line. In addition, a magnetically active gap remains in the described track that corresponds to the addition of the expansion gap, the mounting gap and the doubled thickness of the corrosion protection coating.

There are close tolerance requirements regarding the positioning of stator packets in tracks of the type concerned here since during the travel operation the interval from the carrier- and exciter magnets fastened on the vehicle and the bottom of the stator packets is only a few millimeters. In known tracks the individual stator packets are fastened individually to a functional part or a stator carrier, e.g., by adhesion, welding, screwing, riveting and/or by other connections. The individual stator packets have no connection to each other in this instance. The admissible lateral and height offset of adjacent stator packets is in an extremely close [narrow] millimeter range. Thus, in the known, individual fastening of the stator packets to a stator carrier or to the functional part a high construction- and mounting cost results for maintaining the required, close tolerances.

The present invention therefore has the problem of avoiding the cited disadvantages.

This problem is solved by a track, a kit and a stator packet with the features of the independent claims.

A track in accordance with the invention for a railborne vehicle with a long-stator linear drive comprising at least one long stator consists of a plurality of track elements arranged along a line. The individual track elements comprise a carrier and at least one functional part arranged on it, which functional part comprises at least one stator carrier arranged along the line for receiving at least one stator section. A stator section comprises at least one but as a rule, however, several stator packets with a front and a back joining end. The functional part with the stator carrier, stator sections and stator packets can be pre-mounted and attached at the construction site to the, e.g., concrete or steel carrier. The invention provides that the longitudinal extension of the front joining end of a stator packet has a spatial contour extending out of a cross-sectional plane of the stator packets and the longitudinal extension of the back joining end of the stator packet has a spatial countercontour corresponding with the contour. “Front joining end of a stator packet” denotes the joining end facing in the direction of the travel line and “back joining end of a stator packet” denotes the joining end facing in the particular opposite direction. If stator sections with stator packets formed in accordance with the invention are combined to a long stator, adjacent stator packets overlap in the longitudinal direction.

Thus, tracks for any railborne vehicles with a longitudinal-stator linear drive can be realized using corresponding [appropriate] carrier-and guidance means. The invention can be used, e.g., in systems based on the traditional wheel-rail principle. In this instance the track can have one or several parallel long stators. A track in accordance with the invention can be used with preference in magnetic suspended railways based on the principle of electromagnetic suspension. In order to achieve a stable suspended stage in this instance several long stators placed in parallel are provided. As a rule, a long stator is arranged on the left and the right side of the track.

In a track in accordance with the invention adjacent stator packets of a stator line overlap by an appropriate forming of the front joining end as well as by an appropriate forming of the back joining end. If the thickness of the corrosion protection coating and of the material gap measured in the longitudinal direction remains uniform, this results in a decrease of the magnetic resistance in the gap area. This can be understood as a decrease of the active magnetic gap width without the necessary expansion gaps, curve gaps and/or mounting gaps as well as the thickness of the corrosion protection coating having to be changed.

In an overlapping of adjacent stator packets at least part of the magnetic field lines overcoming the gap run transversely to the longitudinal direction. The field lines have a shorter path to be bridged outside of the bundles of laminations. For example, the interval of bundles of laminations in the area of flanks running vertically to a cross-sectional plate is determined solely by the doubled thickness of the corrosion protection coating. The decrease of the magnetic resistance is now based on the ferromagnetic properties of the stator laminations customarily used. Ferromagnetic substances have a specific magnetic resistance that is less by a factor of 50 to 180,000 than the specific magnetic resistance of air. Even if one considers that the magnetic field lines in the arrangement of interest here have a slightly longer path to traverse on account of their transverse component, the resulting magnetic resistance drops on account of the ferromagnetic materials. The precise value of the magnetic transitional resistance is substantially a function here of the geometry and of the type of materials used.

This means for the traveling field generated by the primary component of the long-stator linear motor a more uniform course of the magnetic induction density and, as a result thereof, an evening out of the drive forces in the course of space and time. Thus, a distinct reduction of the periodic fluctuations of the drive forces takes place during travel operation. In the case of magnetic suspended railways these considerations apply in an analogous manner to the fields and forces of the carrier magnets. Therefore, on the whole the occurrence of periodically changing fluctuations of the drive- and carrier forces can be effectively reduced by the overlapping of adjacent stator packets. This automatically reduces the danger that parts of the track or of the vehicle are put in oscillations that would negatively affect the travel comfort, the development of noise and/or the ability to maintain the systems or system parts. This advantage is particularly significant in magnetic suspended railways in the high-speed range since the frequencies of the oscillations excited in it are the lower sound range. At a speed of 360 km/h and a stator packet length of 1 m, for example, a frequency of approximately 100 Hz results. If any system component has this precise frequency as resonance frequency, which is not improbable, then the cited advantages become especially apparent.

Another advantage results from the fact that the carrier magnets as well as the traveling-field windings must be loaded with a lesser current in order to produce the same average action of force. This results in lesser dissipations [power losses] such as, e.g., ohmic dissipations in the windings and their supply lines. Therefore, an improved energy balance results on the whole.

Another advantage of the invention is apparent in the mounting of the stator packets on the stator carrier. Before the stator packets can be connected by adhering, welding, screwing, riveting and/or in some other manner to the stator carrier the parts must be positioned relative to each other and fixed. Contours, in conformity with the invention, of the joining ends of the stator packets can be designed in such a manner that they can function both as a guide for positioning the stator packets and for fixing in mounting position.

Furthermore, an appropriate contouring can achieve a redundancy of the fastening of the stator packets. The contouring can be designed in such a manner that the stator packet remains at least temporarily within the required tolerance upon the breaking of one or more suspensions of a position [set]. This can prevent a vehicle from making contact during travel operation with a partially separated stator packet and prevent accidents. The defect can then be eliminated during the next routine examination of the track.

It is especially advantageous if the countercontour of a stator packet is derived from the contour by a parallel shifting along the longitudinal axis. Thus, taking into consideration the necessary width, the least possible magnetic resistance results for any contour and countercontour.

Stator packets whose contour and countercontour form level oblique surfaces are particularly easy to manufacture. Level surfaces rotated about the transverse axis can be obtained, e.g., by using the same trapezoidal stator laminations [lamellae]. Oblique surfaces rotated about the vertical axis [of plane] can be formed at least approximately by using stator laminations with different lengths or the offset arrangement of equally long stator laminations.

Contour and countercontour can also basically comprise curved elements. However, it is preferable for technical reasons of manufacture if the contours are limited by one or more level surfaces.

Contour and countercontour can be formed, e.g., as corresponding stepped profiles. Such a profile can be readily manufactured but can have a strong overlapping.

It is advantageous if the counter and countercontour have corresponding recesses and elevations in order to form a cogging. A cogging can function as a guide and fixing of the stator packets.

A vertically acting cogging whose flanks run substantially parallel to the travel plane can prevent a shifting of adjacent stator packets along the vertical axis. This is desirable during mounting as well as during travel operation.

If the contour and the countercontour have a vertically acting cogging of their flanks running substantially parallel to the travel plane, a shifting of adjacent joining ends relative to each other along the transverse axis is prevented.

A horizontally and vertically acting cogging can also be provided with advantage. In this instance flanks are provided that cross or whose imaginary extensions cross. This achieves an especially good fixing during mounting and in the subsequent travel operation.

It can also be practical, depending on how the stator packets are fastened to the stator carrier, if the contour and the countercontour are designed in such a manner that an engagement acting in the longitudinal direction is achieved. This can be achieved by flanks extending behind each other at least partially. The flanks extending behind each other can have a play so that the function of the expansion slot remains preserved.

If the contour and the contour are designed in such a manner that they can be brought into each other by a rotation about the vertical axis of the stator packet, this results in the advantage that the distinguishing of the front and of the back joining ends is eliminated during the mounting.

The contour and the contour can advantageously have corresponding recesses and elevations arranged like a chessboard. This allows a vertically and horizontally acting cogging to be realized in which the mounting does not have to be distinguished according to the front and the back joining end.

In order to facilitate the mounting the surfaces and edges of the contour and of the countercontour can have bevelings [slopes, facets] and/or champfers.

The contour and the countercontour are advantageously designed in such a manner that adjacent and overlapping stator packets can rotate against each other as concerns the vertical axis, transverse axis and/or longitudinal axis. This avoids tensions in the longitudinal stator that can occur during the initiation of a rise, a superelevated or non-superelevated curve.

It can furthermore be advantageous if the material gap between adjacent stator packets within a stator section has a different width than the width of the material gap between adjacent stator packets of stator sections bordering on each other. This can be the case, e.g., if the individual stator sections are pre-mounted on the stator carrier in a factory and the stator carriers with the stator packets are fastened to the carrier in the course of the line. It is advantageous in this case if the gap widths are selected to be larger in the joining area of different stator carriers in order to facilitate the mounting.

It can also be advantageous to provide different gap shapes according to the position in a stator section.

It is especially advantageous if the spatial contour and the corresponding countercontour of adjacent stator packets are designed in such a manner that that different polygonal course lengths of parallel longitudinal stators occurring in curved track sections are balanced out by an overlapping. It can also be provided that differently formed joining surfaces are used in curved travel sections.

If adjacent stator packets are cogged [geared] to each other in such a manner that if the suspension of a stator packet fails this stator packet drops onto the cogging of the other stator packet and thus reveals the defect, this is very advantageous for the monitoring of the track and a reliable travel operation. The cogging can be dimensioned in its geometry in such a manner that the stator packet drops in a purposeful manner by a predetermined amount, e.g., 4 mm. This geometric offset can be detected when the vehicle travels over it and repaired in a purposeful manner by mechanics.

The features described for the track also apply to a kit, a carrier or a stator packet. The kit of the invention, the carrier as well as the stator packet result, when used to make tracks, in the advantages already described.

The invention is explained in detail in the following using the figures.

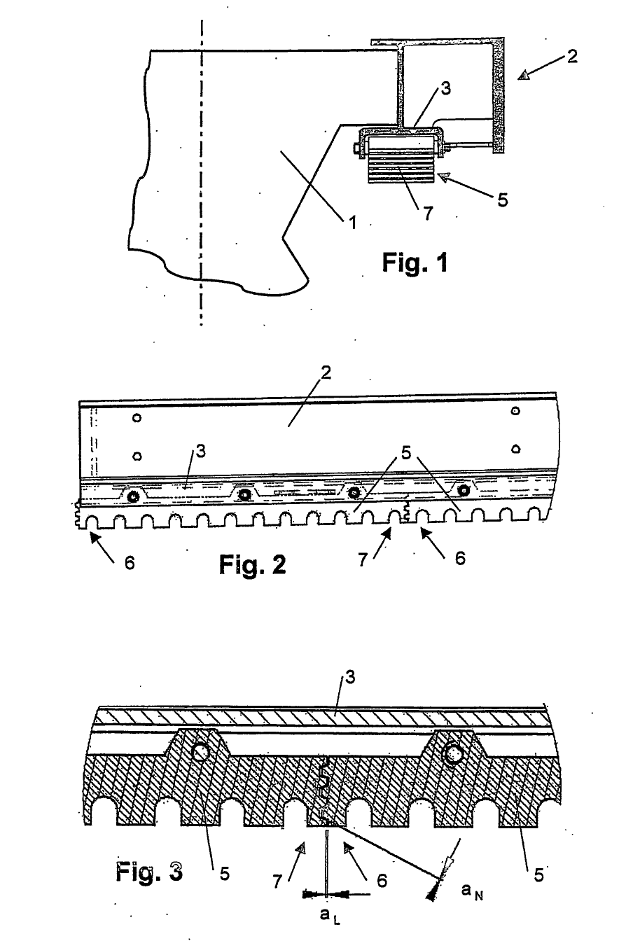

FIG. 1 shows a part of the track in cross section.

FIG. 2 shows a functional part with stator carrier and stator packets in longitudinal section.

FIG. 3 shows an enlarged view of the joining ends of adjacent stator packets.

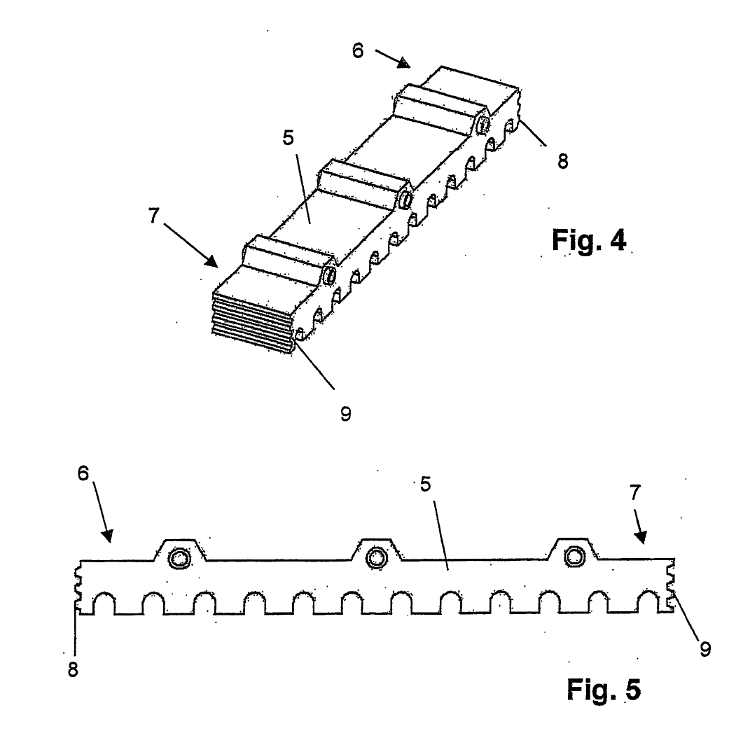

FIG. 4 shows a perspective view of a stator packet.

FIG. 5 shows a stator packet in longitudinal section.

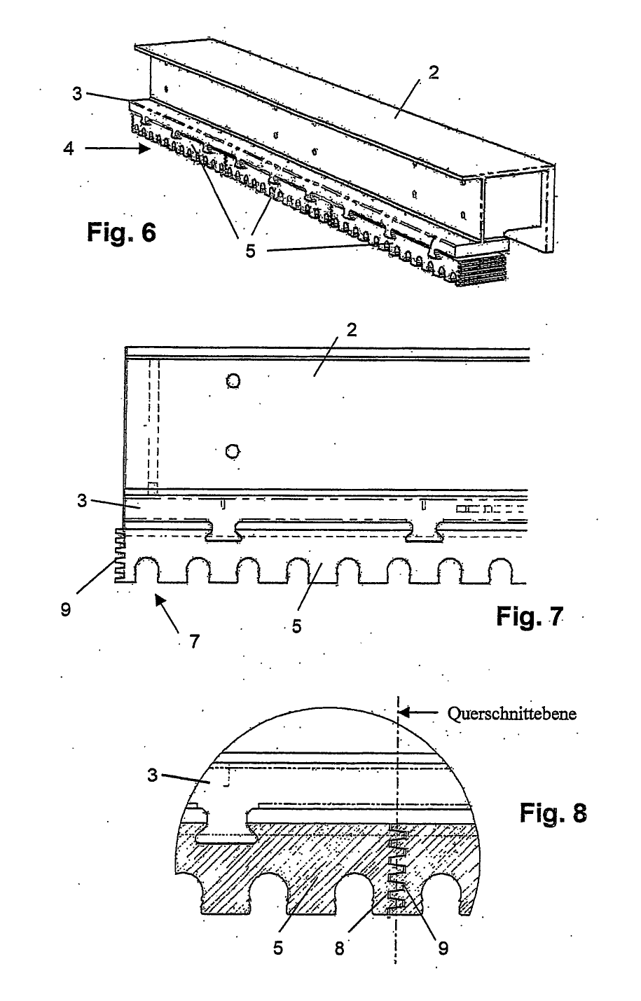

FIG. 6 shows a perspective view of a functional part and of a stator section arranged on it.

FIG. 7 shows a part of a functional part with stator carrier and stator packet.

FIG. 8 shows an enlarged view of the joining area of two adjacent stator packets.

FIG. 1 shows a part of a cross section of a carrier 1 on the side of which functional part 2 is arranged. Functional part 2 comprises U-shaped stator carrier 3 on which stator packet 5 is arranged. In order to suppress eddy currents, stator packet 5 can be formed from stator lamellae insulated from each other.

FIG. 2 shows a part of the longitudinal section through the track. Stator carrier 3 is arranged on functional part 2, on which carrier stator packets 5 with three bolts each are fastened. Represented joining ends 6, 7 of stator packets 5 have elevations and recesses so that a vertically acting cogging is formed. If, e.g., the right and the middle bolt of left stator packet 5 loosen, this package is still held in its position by the cogging and the U-shaped profile of the stator carrier. Reasons for a loosening of the bolts can be, e.g., agitations occurring during travel operation, corrosion damage or mounting errors. On the whole, a redundant fastening of the individual stator packets is ensured here so that a contact of a vehicle with a stator packet is avoided during high-speed travel operation.

FIG. 3 shows a section of a longitudinal section of the same track in the area of joining ends 6, 7 of adjacent stator packets 5. Joining ends 6, 7 of adjacent stator packets 5 have a vertically acting cogging. The gap between adjacent stator packets 5, measured in the longitudinal direction, has the width a_{L} and comprises the expansion gap as well as the mounting gap. The normal interval a_{N} of adjacent tooth flanks is distinctly less than longitudinal gap a_{L}. This has the effect that at least a part of the field lines of the traveling field and/or of the exciter field passes from one stator packet 5 to the other in the area of the tooth flanks. This reduces the effectively active magnetic gap.

FIG. 4 shows a spatial view of a stator packet 5 in accordance with the invention. The stator packet has a front and a back joining end 6, 7 and front joining end 6 has a contour 8 and back joining end 7 a corresponding countercontour 9. Contour 8 and countercontour 9 have corresponding recesses and elevations whose flanks run substantially parallel to the travel plane in order to form an approximately vertically acting cogging. The flanks are beveled in order to facilitate the mounting of adjacent stator packets on stator carrier 3. FIG. 5 shows stator packet 5 in longitudinal section.

FIG. 6 shows another exemplary embodiment of the present invention. It shows a perspective view of a functional part 2 with stator carrier 3 and stator section 4 formed from three stator packets 5 arranged on it. The stator packets are fastened to the stator carrier with traverse-like connection elements extending positively into undercuts of grooves. Longitudinal gap a_{L} between stator packets arranged on functional part 2 is typically 2 mm and longitudinal gap a_{L} on the transitions of functional parts 2 can advantageously be selected to be distinctly greater with, e.g., 4 mm.

FIG. 7 shows a cutout of a longitudinal section of the same arrangement.

FIG. 8 shows an enlarged cutout of abutting joining ends 6, 7 of two stator packets 5. Front and back joining ends 6, 7 have a contour 8 and corresponding countercontour 9 extending out of the illustrated cross-sectional plane. In the example shown the stator packets can be thrust laterally into the stator carrier for mounting and subsequently fixed, e.g., by an adhesive technique.

The present invention is not limited to the exemplary embodiment shown and described but rather modifications are possible within the scope of the claims.

1. A track for a railborne vehicle with a long-stator linear drive:
comprising at least one long stator, with a plurality of track elements arranged along a line, comprising a carrier (1), at least one functional part (2) arranged on the carrier, which functional part (2) comprises at least one stator carrier (3) arranged along the line for receiving at least one stator section (4), which stator section (4) is composed of one or more stator packets (5) with a front (6) and a back (7) joining end, characterized in that the longitudinal extension of the front joining end (6) has a spatial contour (8) extending out of a cross-sectional plane of the stator packets (5), that the longitudinal extension of the back joining end (7) has a spatial countercontour (9) corresponding with the contour (8), and that the front joining end (6) and the back joining end (7) of adjacent stator packets (5) overlap in the longitudinal direction.

2. The track according to the previous claim, characterized in that the contour (8) and the countercontour (9) are designed in such a manner that the contour (8) and the countercontour (9) can be fitted into one another by being shifted parallel to the longitudinal axis of the stator packet (5).

3. The track according to one of the previous claims, characterized in that the contour (8) and the countercontour (9) are designed in such a manner that they have at least approximately two parallel, level, oblique surfaces.

4. The track according to one of the previous claims, characterized in that the contour (8) and the countercontour (9) are designed in such a manner that they are limited by corresponding, at least approximately level surfaces.

5. The track according to one of the previous claims, characterized in that the contour (8) and the countercontour (9) are designed in such a manner that they that they have at least approximately two corresponding stepped profiles.

6. The track according to one of the previous claims, characterized in that the contour (8) and the countercontour (9) have corresponding recesses and elevations in order to form a cogging.

7. The track according to one of the previous claims, characterized in that the contour (8) and the countercontour (9) have corresponding recesses and elevations whose flanks run substantially parallel to the travel plane in order to form an at least approximately vertically acting cogging.

8. The track according to one of the previous claims, characterized in that the contour (8) and the countercontour (9) have corresponding recesses and elevations whose flanks run substantially parallel to a longitudinal sectional plane of the stator packet in order to form a cogging acting at least approximately transversely to the direction of travel.

9. The track according to one of the previous claims, characterized in that the contour (8) and the countercontour (9) have corresponding recesses and elevations whose flanks are aligned in a crossing manner in a cross-sectional plane of the stator packet in order to form an a vertically and horizontally acting cogging.

10. The track according to one of the previous claims, characterized in that the contour (8) and the countercontour (9) have corresponding flanks extending at least partially behind one another in order to form an engagement acting in the longitudinal direction.

11. The track according to one of the previous claims, characterized in that the contour (8) and the countercontour (9) are designed in such a manner that the contour (8) and the countercontour (9) can be brought into one another by a rotation about the vertical axis of the stator packet (5).

12. The track according to one of the previous claims, characterized in that the contour (8) and the countercontour (9) have corresponding recesses and elevations arranged like a chessboard in order to form an a vertically and horizontally acting cogging.

13. The track according to one of the previous claims, characterized in that the contour (8) and the countercontour (9) have corresponding surfaces and/or edges with bevelings [slopes, facets] and/or champfers to facilitate the mounting.

14. The track according to one of the previous claims, characterized in that the contour (8) and the countercontour (9) are designed in such a manner that that adjacent and overlapping stator packets can rotate against each other as concerns the vertical axis, transverse axis and/or longitudinal axis.

15. The track according to one of the previous claims, characterized in that the material gap between adjacent stator packets (5) within a stator section (4) has a different width than the width of the material gap between adjacent stator packets (5) of stator sections (4) bordering on each other.

16. The track according to one of the previous claims, characterized in that front and back joining ends (6, 7) that are adjacent within a stator section (4) have a first spatial contour (8) and corresponding countercontour (9) and that adjacent front and back joining ends (6, 7) belonging to different stator packets have a second spatial contour (8) and corresponding countercontour (9).

17. The track according to one of the previous claims, characterized in that the spatial contour (8) and the corresponding countercontour (9) of adjacent stator packets (5) of one or several standard lengths are designed in such a manner that different polygonal course lengths of parallel long stators occurring in curved track sections are compensated by an overlapping.

18. The track according to one of the previous claims, characterized in that adjacent stator packets (5) are cogged to each other in such a manner that upon the failure of the suspension of a stator packet (5) the stator packet (5) drops onto the cogging of the other stator packet (5) and thus reveals the defect.

19. A kit for constructing tracks for a railborne vehicle with a long-stator linear drive comprising at least one long stator, characterized in that the kit contains stator packets (5) in accordance with one of the previous claims.

20. A carrier for a track for a railborne vehicle with a long-stator linear drive comprising at least one long stator, on which carrier (1) at least one functional part (2) is arranged, which functional part (2) comprises at least one stator carrier (3) arranged along the carrier (1) for receiving at least one stator section (4), which stator section (4) is composed of one or several stator packets (5) with a front joining end (6) and a back joining end (7), characterized in that the longitudinal extension of the front joining end (6) has a spatial contour (8) extending out of a cross-sectional plane of the stator packets (5), that the longitudinal extension of the back joining end (7) has a spatial countercontour (9) corresponding to the contour (8), and that the front joining end (6) and the back joining end (7) of adjacent stator packets (5) overlap in the longitudinal direction.

21. A stator packet for a track for a railborne vehicle with a long-stator linear drive, a plurality of stator sections (4) arranged along a line, which stator sections are composed of one or several stator packets (5) with a front (6) and a back (7) joining end, characterized in that the longitudinal extension of the front joining end (6) has a spatial contour (8) extending out of a cross-sectional plane of the stator packets (5), that the longitudinal extension of the back joining end (7) has a spatial countercontour (9) corresponding to the contour (8), and that the front joining end (6) and the back joining end (7) of adjacent stator packets (5) overlap in the longitudinal direction.
